(19) United States
(12) Patent Application Publication
(10) Pub. No.: US 2025/0042352 A1
(43) Pub. Date: Feb. 6, 2025

(54) SYSTEM AND METHOD FOR DETERMINING OCCUPANCY WITH AN INTERMITTENT OCCUPANCY SENSOR RESPONSE

(71) Applicant: GM Global Technology Operations LLC, Detroit, MI (US)

(72) Inventor: Scott D. Thomas, Novi, MI (US)

(73) Assignee: GM Global Technology Operations LLC, Detroit, MI (US)

(21) Appl. No.: 18/365,051

(22) Filed: Aug. 3, 2023

(51) Int. Cl. B60R 21/015; B60R 22/48

(52) U.S. Cl. CPC B60R 21/01546; B60R 22/48; B60R 2022/4816; B60R 2022/4858

(57) ABSTRACT

A system includes an occupant detection module configured to identify an occupied state when an occupant is seated on a vehicle seat and an unoccupied state when the vehicle seat is free from an occupant. The system also includes a buckle sensor configured to identify a time of buckling when a latch plate is initially secured to a buckle. A seatbelt wear condition module is configured to identify the occupied state at the time of buckling and after buckling regardless of whether the occupant detection module detects the occupied state at the time of buckling and after buckling or the unoccupied state at the time of buckling and after buckling based on the occupant detection module identifying the occupied state within a predetermined timeframe prior to the time of buckling and disregarding any unoccupied state produced from the occupant detection module while the seatbelt remains buckled.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates to a system and method for determining occupancy with an intermittent seat occupancy sensor response before, during, and after buckling of a seatbelt assembly.

Restraint systems are used in modern vehicles to restrain an occupant during use of the vehicle. Such systems may include one or more airbags located proximate to each seating location of the vehicle that work in conjunction with a seatbelt assembly dedicated for use with a particular seating location.

Conventional seatbelt assemblies typically include seatbelt webbing, a tongue or latch plate, a seatbelt buckle, a retractor, a lower anchor, and a seatbelt guide loop or D-ring that receives the seatbelt webbing and properly positions the seatbelt webbing relative to an occupant during use. The seatbelt webbing is typically anchored at a first end to a vehicle structure by the lower anchor and extends up from the vehicle structure in a direction toward a vehicle seat. The seatbelt webbing continues in a direction towards the guide loop or D-ring where the seatbelt webbing is routed through the guide loop or D-Ring before being received by the retractor. The retractor is typically mounted to vehicle structure or vehicle seat structure and permits payout of the seatbelt when an occupant exerts a force on the seatbelt webbing to extract a desired length of the seatbelt webbing from the retractor. The seatbelt webbing slidably receives the tongue or latch plate along a length of the seatbelt webbing. The tongue or latch plate may be selectively attached to the seatbelt buckle on an opposite side of the vehicle seat than the lower anchor to restrain an occupant in the vehicle seat during use. The seatbelt retractor also serves to automatically retract/pull the seatbelt webbing into the retractor when the tongue or latch plate is disengaged from the seatbelt buckle, thereby returning the seatbelt webbing to a stowed state.

In operation, a user may sit in a vehicle seat and apply a force on the seatbelt webbing and/or on the tongue or latch plate to extract a desired length of the seatbelt webbing from the retractor. The retractor, in response to the force applied to the seatbelt webbing and/or the tongue or latch plate, permits a length of the seatbelt webbing to be extracted from the retractor, thereby increasing the effective length of the seatbelt webbing between the retractor and the lower anchor. Once a desired length of the seatbelt webbing is achieved, the occupant aligns the tongue or latch plate with the seatbelt buckle and inserts the tongue or latch plate into the seatbelt buckle, thereby fixing a relative position of the tongue or latch plate and the seatbelt buckle. At this point, the seatbelt webbing, when properly worn by the occupant, extends across an upper torso of the occupant from the D-ring or retractor to the tongue or latch plate and extends from the tongue or latch plate across a lap of the occupant between the tongue or latch plate and the lower anchor. Once the tongue or latch plate is attached to the seatbelt buckle, the retractor restricts further payout of the seatbelt webbing and snugs the seatbelt webbing against the occupant with a very low force level to restrain the occupant in the vehicle seat during use.

When the occupant wishes to leave the vehicle seat, a force may be applied to button of the seatbelt buckle to release the tongue or latch plate from the seatbelt buckle. At this point, the retractor automatically spools the seatbelt webbing into the retractor, thereby reducing an effective length of the seatbelt webbing between the retractor and the lower anchor. Once a predetermined length of the seatbelt webbing is retracted into the retractor, the seatbelt is returned to the stowed state.

While conventional seatbelt assemblies adequately restrain an occupant on a vehicle seat, determining whether an occupant is seated on the vehicle seat at the time of buckling is often challenging due to movement of an occupant during buckling of the seatbelt. For example, when an occupant initially sits on a vehicle seat, a sensor associated with the seat may detect the presence of the occupant. However, after the initial force spike when seating, the occupant's force level on the seat decreases, which may cause the sensor to identify the seat as being unoccupied. In addition, movement of the occupant away from a seat bottom of the seat during buckling may cause the sensor to identify the seat as being unoccupied. While a remotely located sensor (i.e., a sensor not located in the seat) can be used to determine if the seat is occupied, such a sensor may also be fooled at times when an occupant is present depending on sensor type, lighting conditions, and materials obscuring the sensor's view of the occupant. Accordingly, a module monitoring the seatbelt assembly may incorrectly identify the seat as being unoccupied even though a tongue or latch plate is secured to a buckle and an occupant is seated in the vehicle seat and is restrained by the seatbelt.

### SUMMARY

In one configuration, a system includes an occupant detection module configured to identify a state of a vehicle seat, the occupant detection module identifying an occupied state when an occupant is seated on the vehicle seat and an unoccupied state when the vehicle seat is free from an occupant. The system also includes a buckle sensor configured to detect a buckled state when a latch plate is secured to a buckle of a seatbelt and an unbuckled state when the buckle is separated from a latch plate, the buckle sensor identifying a time of buckling when the latch plate is initially secured to the buckle. A seatbelt wear condition module is in communication with the buckle sensor and the occupant detection module and is configured to identify the occupied state at the time of buckling and after buckling regardless of whether the occupant detection module detects the occupied state at the time of buckling or the unoccupied state at the time of buckling based on the occupant detection module identifying the occupied state prior to the time of buckling.

The system may include one or more of the following optional features. For example, the seatbelt wear condition module may be configured to detect the occupied state at the time of buckling based on the occupant detection module identifying the occupied state within a window of time starting before the time of buckling and ending at and including the time of buckling.

In one configuration, the predetermined timeframe may fall within an approximate timeframe from two (2) to ten (10) seconds.

The seatbelt wear condition module may identify the occupied state at the time of buckling regardless of whether the occupant detection module detects intermittent occupancy at the time of buckling based on the occupant detection module identifying the occupied state within a predetermined timeframe prior to the time of buckling, at a point-in-time during buckling, or during a timeframe after buckling. The predetermined timeframe may fall within an approximate timeframe from two (2) to ten (10) seconds starting before the time of buckling and ending at and including the time of buckling.

In one configuration, the occupant detection module may be in communication with at least one occupancy sensor configured to determine the presence of an occupant on the vehicle seat. The at least one occupancy sensor may include at least one of a pressure sensor, a weight sensor, a resistive sensor, a biometric sensor, and a capacitive sensor located in the vehicle seat and a remote sensor including at least one of a camera, radar, and LIDAR having a field-of-view that encompasses the vehicle seat. The seatbelt wear condition module may store the state of the vehicle seat as detected by an occupancy sensor for a continuous fixed duration moving time window prior to and including the time of buckling.

In another configuration, a system includes an occupant detection module configured to identify a state of a vehicle seat, the occupant detection module identifying an occupied state when an occupant is seated on the vehicle seat and an unoccupied state when the vehicle seat is free from an occupant. The system additionally includes a buckle sensor configured to detect a buckled state when a latch plate is secured to a buckle of a seatbelt and an unbuckled state when the buckle is separated from a latch plate, the buckle sensor identifying a time of buckling when the latch plate is initially secured to the buckle. A seatbelt wear condition module is in communication with the buckle sensor and the occupant detection module and is configured to identify the occupied state at the time of buckling regardless of whether the occupant detection module detects the occupied state at the time of buckling or the unoccupied state at the time of buckling based on the occupant detection module identifying the occupied state within a predetermined timeframe prior to and including the time of buckling.

The system may include one or more of the following optional features. For example, the seatbelt wear condition module may be configured to communicate the occupancy of the vehicle seat at the time of buckling to at least one of an internal user interface device and an external user interface device.

In one configuration, the predetermined timeframe may fall within an approximate timeframe from two (2) to ten (10) seconds.

The seatbelt wear condition module may identify the occupied state at the time of buckling regardless of whether the occupant detection module detects intermittent occupancy at the time of buckling based on the occupant detection module identifying the occupied state within the predetermined timeframe prior to the time of buckling, at a point-in-time during buckling, or during a timeframe after buckling. The predetermined timeframe may fall within an approximate timeframe from two (2) to ten (10) seconds starting before the time of buckling and ending at and including the time of buckling.

In one configuration, the occupant detection module may be in communication with at least one occupancy sensor configured to determine the presence of an occupant on the vehicle seat. The at least one sensor may include at least one of a pressure sensor, a weight sensor, a resistive sensor, a biometric sensor, and a capacitive sensor located in the vehicle seat and a remote sensor including at least one of a camera, radar, and LIDAR having a field-of-view that encompasses the vehicle seat. The seatbelt wear condition module may store the state of the vehicle seat as detected by an occupancy sensor for a continuous fixed duration moving time window prior to and including the time of buckling.

In yet another configuration, a system includes an occupant detection module configured to identify a state of a vehicle seat, the occupant detection module identifying an occupied state when an occupant is seated on the vehicle seat and an unoccupied state when the vehicle seat is free from an occupant. The system also includes a buckle sensor configured to detect a buckled state when a latch plate is secured to a buckle of a seatbelt and an unbuckled state when the buckle is separated from a latch plate, the buckle sensor identifying a time of buckling when the latch plate is initially secured to the buckle. A seatbelt wear condition module is in communication with the buckle sensor and the occupant detection module and is configured to identify the occupied state after a buckling event while the seatbelt remains buckled regardless of whether the occupant detection module detects the occupied state after the buckling event while the seatbelt remains buckled or the unoccupied state after the buckling event while the seatbelt remains buckled based on the occupied state determined at buckling.

The system may include one or more of the following optional features. For example, the seatbelt wear condition module may identify the occupied state after buckling when the seatbelt remains buckled if the occupant detection module detects an unoccupied state after buckling while remaining buckled.

In one configuration, the occupant detection module may be in communication with at least one occupancy sensor configured to determine the presence of an occupant on the vehicle seat. The at least one occupancy sensor may include at least one of a pressure sensor, a weight sensor, a resistive sensor, a biometric sensor, and a capacitive sensor located in the vehicle seat and a remote sensor including at least one of a camera, radar, and LIDAR having a field-of-view that encompasses the vehicle seat.

### BRIEF DESCRIPTION OF THE DRAWINGS

The drawings described herein are for illustrative purposes only of selected configurations and are not intended to limit the scope of the present disclosure.

FIG. 1 is a schematic view of a vehicle system according to the principles of the present disclosure;

FIG. 2 is a functional block diagram of an example control system in accordance with the principles of the present disclosure for use for use in conjunction with the vehicle system of FIG. 1;

FIG. 3 is a front view of an occupant seated on a vehicle seat with a seatbelt assembly unbuckled;

FIG. 4 is a graphical representation of a state of a buckle of the seatbelt assembly of FIG. 3 and a state of an occupant detection device over time for the seated occupant shown in FIG. 3;

FIG. 5 is a front view of an occupant seated on a vehicle seat during buckling of a seatbelt assembly;

FIG. 6 is a graphical representation of a state of a buckle of the seatbelt assembly of FIG. 5 and a state of an occupant detection device over time for the seated occupant shown in FIG. 5;

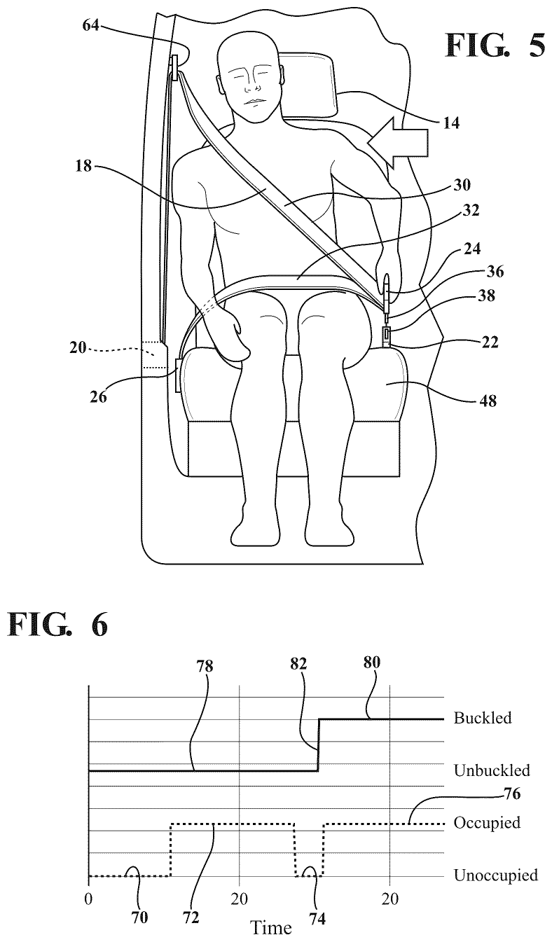

FIG. 5A is a front view of an occupant seated on a vehicle seat after buckling of a seatbelt assembly;

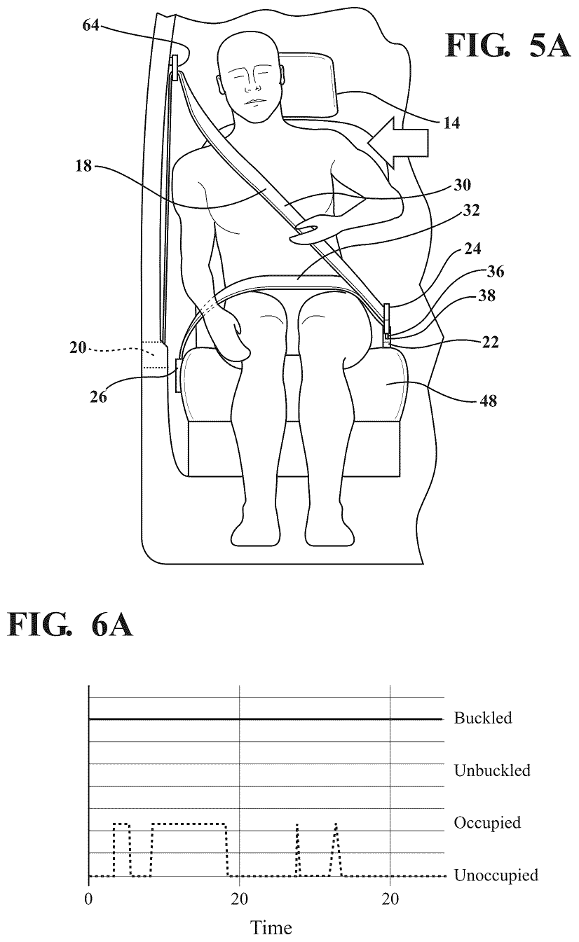

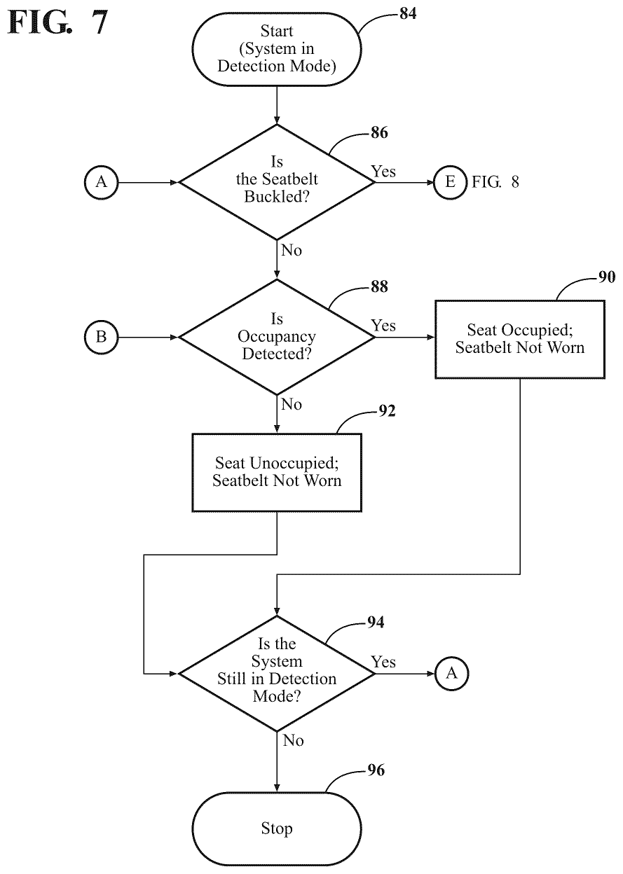

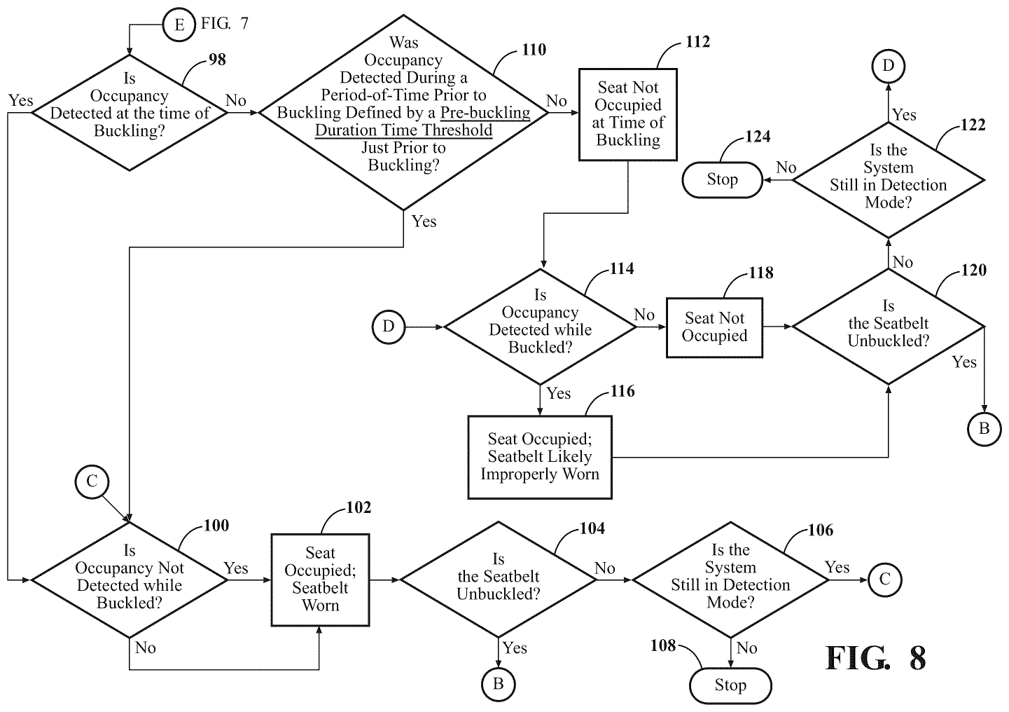

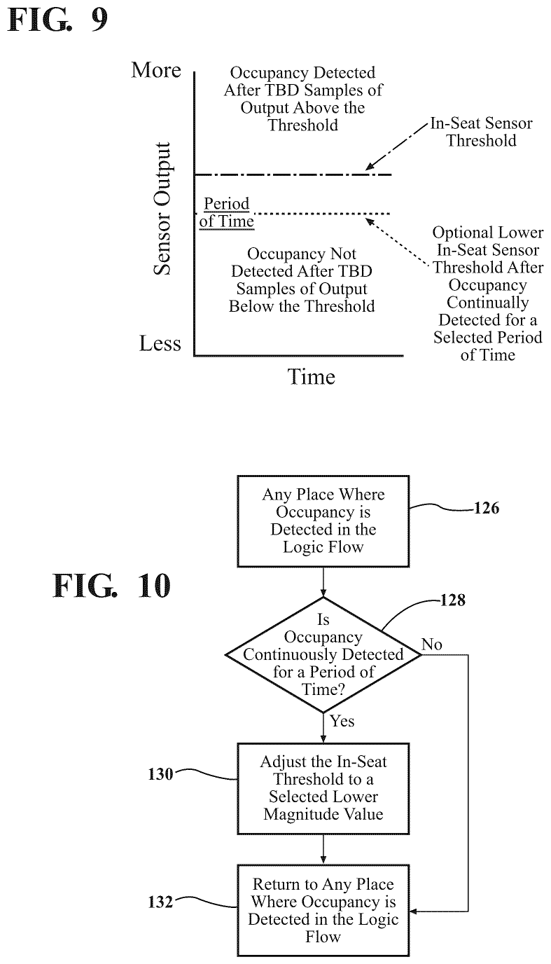

FIG. 6A is a graphical representation of a state of a buckle of the seatbelt assembly of FIG. 5A and a state of an occupant detection device over time for the seated occupant shown in FIG. 5A;

FIGS. 7-8 are flowcharts illustrating example methods for determining occupancy of a seat during a buckling event;

FIG. 9 is a graphical representation of occupant detection sensor output over time; and

FIG. 10 is a flowchart illustrating an example method for adjusting an in-seat occupancy threshold based on continuous detection of an occupant in a seat for a predetermined period of time.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including.” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to.” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below; the term module may be replaced with the term circuit. The term module may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code; memory (shared, dedicated, or group) that stores code executed by a processor: other suitable hardware components that provide the described functionality: or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

A system and method may use the output of a seatbelt buckle sensor and an occupant detection device including an occupancy sensor to determine whether an occupant is seated in a seat during a buckling event. The system and method determine occupancy of an occupant on a seat if the seatbelt buckle sensor identifies a buckling event and, at the same time, the occupancy sensor identifies an occupant as sitting in the seat.

Additionally, the system and method may likewise determine occupancy of an occupant on a seat even if the occupancy sensor does not detect an occupant at the time of buckling. Namely, the system and method may determine occupancy even if the occupancy detection device does not detect occupancy at the time of buckling provided the occupant detection device detected occupancy during a predetermined period of time prior to buckling. In this situation, the system and method accounts for situations where an occupant sits in a seat and, during buckling of a seatbelt into a buckle, temporarily moves away from a seat bottom of the seat. For example, if an occupant initially sits on a vehicle seat, the system and method will record the seat as being occupied based on information from the occupant detection device. As another example, the occupant could be obscured and not viewable by the occupancy sensor if the occupant has a material object between the sensor and the occupant or has a motion where the sensor cannot recognize the occupant. If the occupant is obscured from view, moves away from the seat bottom at the time of buckling in an effort to try and locate the buckle, retrieve a lost item, move away from an adjacent occupant, or for any other reason, and the occupant detection device no longer identifies the seat as being occupied, the system and method will still identify the seat as being occupied at the time of buckling due to the occupant being identified as seated on the seat within a predetermined period of time preceding buckling of the seatbelt into the buckle.

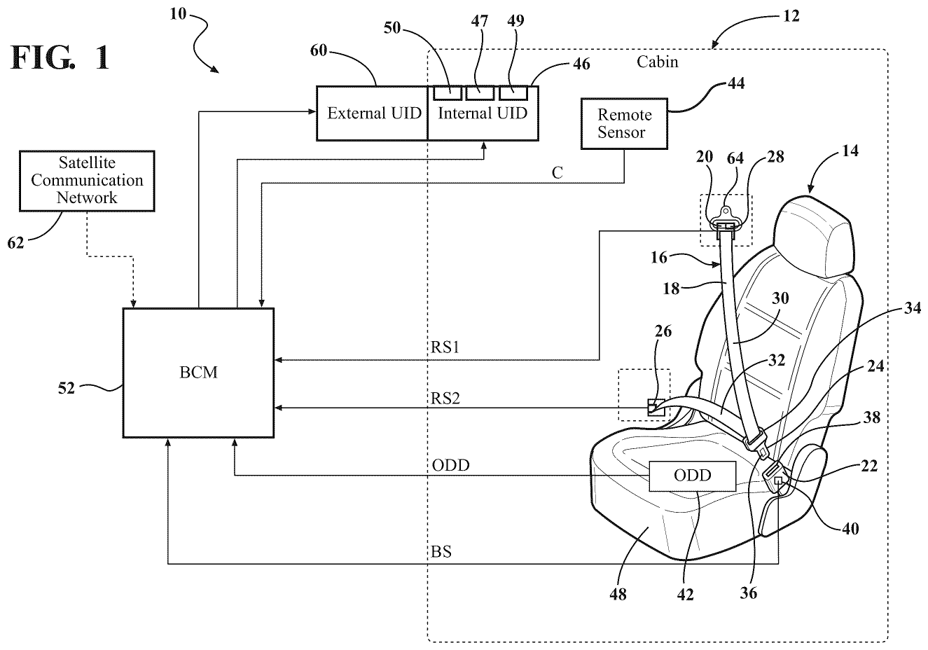

With reference to FIG. 1, a vehicle system 10 is provided and includes a cabin 12 having a seat 14 and seatbelt assembly 16 disposed therein. The seatbelt assembly 16 includes seatbelt webbing 18, a retractor 20, a seatbelt buckle 22, a tongue or latch plate 24, and an anchor 26. The seatbelt webbing 18 extends between a first end attached to the retractor 20 and a second end attached to the anchor 26.

In one configuration, the retractor 20 is physically attached to a vehicle structure such as, for example, a B-pillar or a C-pillar (neither shown). The seatbelt webbing 18 is received within a body of the retractor 20 and is wound around a spool (not shown) of the retractor 20. The retractor 20 may include a seatbelt payout sensor 28 that detects the length of seatbelt webbing 18 extended from and retracted into the retractor 20. The seatbelt payout sensor 28 may be a Hall-effect sensor or a rotary encoder that determines a number or rotations of a spool of the retractor 20 and, in so doing, can detect the length of a seatbelt webbing 18 that is extended from and/or retracted into the retractor 20. Alternatively, the seatbelt payout sensor 28 may be an optical sensor that can determine a number of rotations of the spool of the retractor 20 and, likewise, can determine the length of the seatbelt webbing 18 extended from and/or retracted into the retractor 20. In addition, other types of payout sensing technologies may be utilized.

The anchor 26 may be attached to vehicle structure or the seat 14 such as, for example, a floor pan (not shown) of a vehicle or a seat-to-floor-pan mount (not shown). As such, the anchor 26 is fixed for movement with the cabin 12. The anchor 26 may receive a first end of the seatbelt webbing 18 to likewise fix the first end of the seatbelt webbing 18 relative to the cabin 12. The end of the seatbelt webbing 18 received by and attached to the vehicle by the anchor 26 is disposed at an opposite end of the seatbelt webbing 18 from the retractor 20.

As thus far described, the seatbelt webbing 18 extends from the anchor 26 at one end of the seatbelt webbing 18 to the retractor 20 at an opposite end of the seatbelt webbing 18. In operation, a user may apply a force on the seatbelt webbing 18 to extract a length of the seatbelt webbing 18 from the retractor 20. The length of the seatbelt webbing 18 extracted from the retractor 20 includes a cross-body segment 30 and lap segment 32. As shown in FIG. 1, the cross-body segment 30 extends generally across a torso of an occupant while the lap segment 32 extends across of a lap of an occupant from the seatbelt buckle 22 to the anchor 26. Accordingly, when a force is exerted on the seatbelt webbing 18 such that a length of the seatbelt webbing 18 is extended from the retractor 20, the cross-body segment 30 and the lap segment 32 cooperate to define the length of the seatbelt webbing 18 extending over the vehicle occupant from the retractor 20 to the seatbelt buckle 22 and from the seatbelt buckle 22 to the anchor 26.

While the seatbelt assembly 16 will be described hereinafter and shown in drawings as including a single retractor 20 used in conjunction with an anchor 26, the seatbelt assembly 16 could incorporate a second retractor in place of the anchor 26. In such a system, the cross-body segment 30 would be supplied entirely from the retractor 20 shown in FIG. 1 while the lap segment 32 would be extended from the retractor replacing the anchor 26. If the seatbelt assembly 16 includes a retractor in place of the anchor 26, the retractor 20 could include a seatbelt payout sensor 28 in an identical fashion as the seatbelt payout sensor 28 associated with the retractor 20.

The tongue or latch plate 24 includes a slot 34 and a projection 36 extending from the slot 34. The slot 34 slidably receives the seatbelt webbing 18 to allow the tongue or latch plate 24 to move relative to and along the seatbelt webbing 18. The projection 36 extends from the slot 34 and is selectively received by the seatbelt buckle 22.

The seatbelt buckle 22 is disposed on an opposite side of the seat 14 than the anchor 26 and includes a slot 38 that selectively receives the projection 36 of the tongue or latch plate 24. The seatbelt buckle 22 may be fixed for movement with the seat 14 or, alternatively, made be fixed to vehicle structure such as, for example, the floor pan of the vehicle. In operation, when an occupant applies a force on the seatbelt webbing 18 such that a length of the seatbelt webbing 18 is extended from the retractor 20, the tongue or latch plate 24 may be positioned relative to the seatbelt buckle 22 such that its projection 36 opposes and is received by the slot 38. Once the projection 36 is sufficiently inserted into the seatbelt buckle 22 via the slot 38, a lock mechanism (not shown) of the seatbelt buckle 22 engages the projection 36 of the tongue or latch plate 24, thereby securing the tongue or latch plate 24 to the seatbelt buckle 22.

When a user applies a force to the seatbelt webbing 18 to extract a length of the seatbelt webbing 18 from the retractor 20, the tongue or latch plate 24 may be moved along and relative to the seatbelt webbing 18 via the slot 34. Once the projection 36 of the tongue or latch plate 24 is secured within the slot 38 of the seatbelt buckle 22, the retractor 20 may exert a force on the seatbelt webbing 18 to retract a length of the seatbelt webbing 18 back into the retractor 20. In so doing, the retractor 20 ensures that the seatbelt webbing 18 fits properly and snugly against a lap and torso of the occupant during use.

At this point, lengths of the cross-body segment 30 and the lap segment 32 of the seatbelt webbing 18 are generally defined. As can be appreciated, a relative position between the tongue or latch plate 24 and the seatbelt webbing 18 will vary based upon the size of the occupant seated on the seat 14 and seat 14 position in the vehicle. For example, when a larger occupant is seated 14, a greater length of webbing 18 must be extended from the retractor 20 to accommodate the larger occupant as compared to, for example, a smaller occupant requiring a shorter length of seatbelt webbing 18. Accordingly, the tongue or latch plate 24 will be positioned at a different location along the seatbelt webbing 18 for different vehicle occupants, as the length of the seatbelt webbing 18 required to be extended from the retractor 20 will vary based on the size of the occupant. Likewise, for a person in a full-forward seat position, a longer length of seatbelt webbing 18 may be extended from the retractor 20 that for this person than if they were sitting in a full-rear seat position.

Regardless of the size of the occupant seated on the seat 14, the seat 14 position, and the length of the seatbelt webbing 18 extended from the retractor 20, engagement of the projection 36 of the tongue or latch plate 24 with the seatbelt buckle 22 may be detected by a buckle sensor 40 associated with the seatbelt buckle 22. The buckle sensor 24 detects the presence of the projection 36 disposed within the seatbelt buckle 22 and, as such, produces a signal indicative of the presence of the projection 36 within the seatbelt buckle 22. Detection of the projection 36 within the seatbelt buckle 22 allows the buckle sensor 40 to identify when the tongue or latch plate 24 is securely engaged with the lock mechanism of the seatbelt buckle 22.

When an occupant sits on the seat 14 and extends a portion of the seatbelt webbing 18 from the retractor 20 a sufficient distance in a direction toward the seatbelt buckle 22, the projection 36 of the tongue or latch plate 24 is received within the slot 38. When the projection 36 is sufficiently inserted into the seatbelt buckle 22, the buckle sensor 40 may detect the presence of the projection 36 and generate a signal indicative of the projection 36 being engaged with lock mechanism of the seatbelt buckle 22.

With continued reference to FIG. 1, the vehicle system 10 further includes an occupant detection device (ODD) 42, a remote sensor 44 such as a camera or other sensor, and an internal user interface device (UID) 46. Within this document, the ODD 42 and the remote sensor 44 are collectively referred to as the occupancy sensor. The ODD 42 may include a weight pad (not shown) disposed within a seat bottom 48 of the seat 14. The weight pad is positioned relative to the seat bottom 48 such that when an occupant is seated on the seat 14, the weight pad is able to detect the presence of the seated occupant. While the seat bottom 48 is described as including a weight pad to detect the presence of an occupant, the seat bottom 48 could additionally or alternatively include one or more pressure sensors, ohmmeters, capacitive sensors, resistive sensors, electric field proximity sensors, biometric sensors, and/or other types of sensors capable of detecting the presence of an occupant seated on the seat bottom 48.

The remote sensor 44 may be positioned within the cabin 12 such that the remote sensor 44 has a field-of-view that captures the seat 14. Accordingly, the remote sensor 44 may be used to detect the presence of an occupant seated on the vehicle seat 14. Additionally or alternatively, the remote sensor 44 may be used to determine whether the seatbelt webbing 18 is extended from the retractor 20 and, further, may be used to determine and/or verify the length of the seatbelt webbing 18 extended from the retractor 20. The foregoing information detected by the remote sensor 44 may be used in conjunction with the data provided by the ODD 42 to verify the presence of a vehicle occupant seated in the seat 14. Different types of remote sensors can be used such as a camera, radar, or LIDAR.

The internal UID 46 may be located within the cabin 12 and may include a display 50. The display 50 may be used to communicate information to occupants in the cabin 12 related to the use of the seatbelt assembly 16. Namely, the internal UID 46 may display information on the display 50 regarding whether an occupant is seated in the seat 14, whether the seatbelt is buckled, and/or whether the seatbelt assembly 16 is properly positioned relative to the occupant. In addition, the internal UID 46 can control an audible messaging system 47 and/or a haptic messaging system 49 that may be used to communicate information to an occupant of the cabin 12 regarding whether an occupant is seated in the seat 14, whether the seatbelt is buckled, and/or whether the seatbelt assembly 16 is properly positioned relative to the occupant.

With continued reference to FIG. 1, outputs from the seatbelt payout sensor(s) 28, the buckle sensor 40, the ODD 42, and the remote sensor 44 are provided to a body control module (BCM) 52. Accordingly, the BCM 52 receives data from the seatbelt payout sensor(s) 28 related to the length of seatbelt webbing 18 extended from the retractor 20, from the buckle sensor 40 whether the projection 36 of the tongue or latch plate 24 is securely attached to the lock mechanism of the seatbelt buckle 22, from the ODD 42 related to whether an occupant is seated on the seat 14, and from the remote sensor 44 pertaining to the presence of an occupant on the vehicle seat 14 and/or the length of seatbelt webbing 18 extended from the retractor 20. As mentioned above, the seatbelt assembly 16 will hereinafter be described and shown as including a single retractor 20 associated with the seat 14. However, the anchor 26 could be replaced with an additional retractor 20 and associated seatbelt payout sensor 28. If the seatbelt assembly 16 includes a retractor 20 in place of the anchor 26, the length of the seatbelt webbing 18 extended from the lower retractor 20—as detected by the associated seatbelt payout sensor 28—would similarly be supplied to the BCM 52 for use by the BCM 52 in determining whether the seatbelt assembly 16 is in proper use.

The output from the seatbelt payout sensor 28 is identified in FIG. 1 along communication line RS1. The output from the buckle sensor 42 to the BCM 52 is identified along communication line BS. The output of the ODD 42 is identified via communication line ODD while the output from the remote sensor 44 is identified along communication line C. Finally, if the seatbelt assembly 16 includes a second retractor 20 in place of the anchor 26, and an associated seatbelt payout sensor 28, the output from the seatbelt payout sensor 28 associated with the lower retractor 20 is shown as extending along communication line RS2. As will be described in greater detail below; the various sensor inputs RS1, RS2, BS, ODD, C, are received by the BCM 52 for use by the BCM 52 in monitoring and diagnosing use of the seatbelt assembly 16.

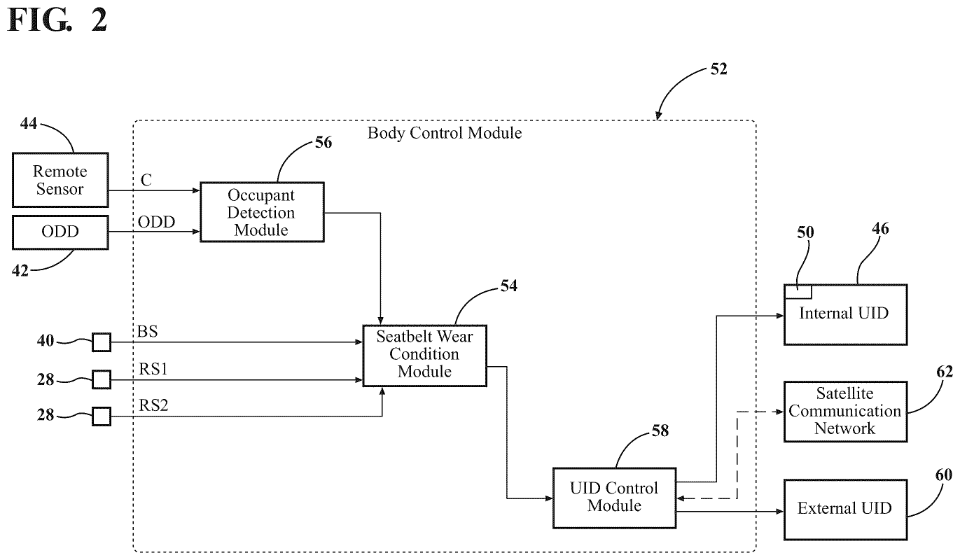

With particular reference to FIG. 2, the body control module 52 is shown as including a seatbelt wear condition module 54, an occupant detection module 56, and a UID control module 58. As shown, the seatbelt wear condition module 54 is in communication with the seatbelt payout sensor 28 and the buckle sensor 40. The seatbelt wear condition module 54 receives information from the seatbelt payout sensor 28 regarding the length of the seatbelt webbing 18 extended from the retractor 20 via communication line RS1 and possibly RS2 and receives information regarding whether the tongue or latch plate 24 is in engaged with the lock mechanism of the seatbelt buckle 22 from the buckle sensor 40 via communication line BS.

The occupant detection module 56 is in communication with the seatbelt wear condition module 54 and receives information from the ODD 44 and remote sensor 44. The occupant detection module 56 receives information from the ODD 42 via communication line ODD regarding whether the ODD 42 detects the presence of an occupant seated on the seat 14. The remote sensor 44 may provide information to the occupant detection module 56 regarding whether an occupant is detected as being seated on the seat 14 and/or regarding the length of the seatbelt webbing 18 extended from the retractor 20 via the communication line C.

As will be described in greater detail below with respect to FIGS. 7-10, the seatbelt wear condition module 54 monitors the state of the seatbelt assembly 16 and, more particularly, may be used to determine whether an occupant is seated on the seat 14 during buckling of the tongue or latch plate 24 into the seatbelt buckle 22.

The seatbelt wear condition module 54 is in communication with the UID control module 58 to provide the UID control module 58 with information regarding the state of the seatbelt assembly 16. For example, the seatbelt wear condition module 54 may provide information to the UID control module 58 that an occupant is seated on the seat 14 and, further, that the occupant is properly buckled. Additionally, the seatbelt wear condition module 54 may determine that a the tongue or latch plate 24 is properly secured to the seatbelt buckle 22 but an occupant is not present on the seat 14. In this situation, the seatbelt wear condition module 54 could determine that an object is buckled in the seat 14, the seatbelt is buckled over an empty seat 14, or that a tongue or latch plate 24 from an adjacent seat 14 is buckled in an incorrect buckle 22. The seatbelt wear condition module 54 may communicate the foregoing information to the UID control module 58 for communication by the internal UID 46 on at least one of the display 50, the audible messaging system 47, and the haptic messaging system 49. Additionally or alternatively, information from the UID control module 58 may be sent directly to an external UID 60) and/or a satellite communication network 62.

The information pertaining to the condition of the seatbelt assembly 16 may be displayed on the external UID 60. For example, the external UID 60 may be a smartphone or a tablet associated with the vehicle's owner or occupant(s). Information pertaining to the seatbelt assembly 16 may be displayed by the external UID 60 on such a smartphone or tablet. Finally, the UID control module 58 may communicate information from the seatbelt wear condition module 54 regarding the state of the seatbelt assembly 16 to the satellite communication network 62, which may be in communication with one or both of the internal UID 46 and the external UID 60. As with the direct communication between the UID control module 58 and the internal UID 46 and the external UID 60, the satellite communication network 62 may provide information from the UID control module 58 as to the state of the seatbelt assembly 16 to one or both of the internal UID 46 and the external UID 60.

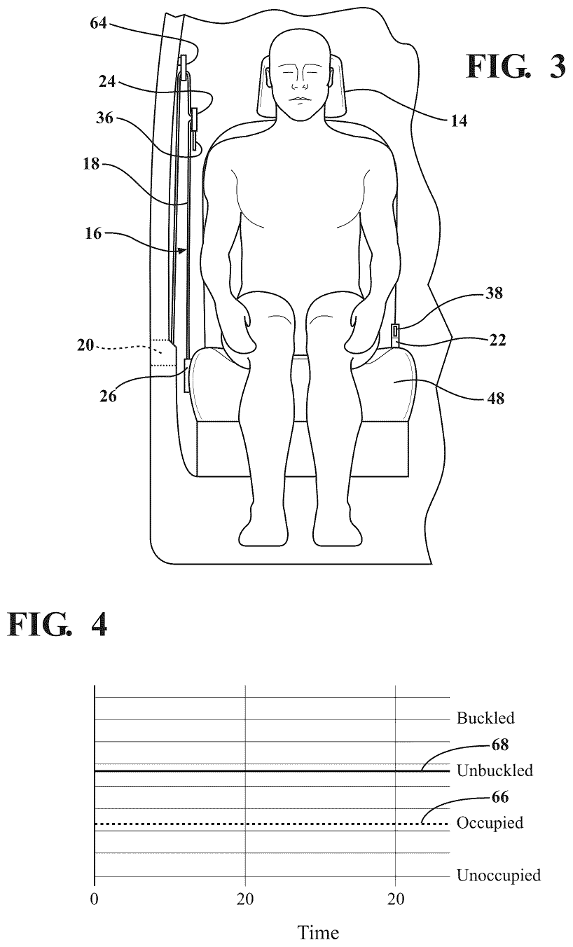

With particular reference to FIG. 3, an occupant is shown as seated on the seat 14 and the seatbelt assembly 16 is in a stowed state. As shown in FIG. 4, the state of the occupant and the state of the seatbelt assembly 16 are recorded over time by the seatbelt wear condition module 54. Specifically, the seat 14 is identified as being occupied at line 66 based on information received from the occupant detection module 56. The information from the occupant detection module 56 may include information from the ODD 42 and/or the remote sensor 44. The state of the seatbelt assembly 16 is identified by line 68 based on information from the seatbelt buckle sensor 40. Specifically, the tongue or latch plate 24 is disengaged from the buckle 22 and, as such, the buckle sensor 40 communicates the state of the buckle 22 (i.e., unbuckled) to the seatbelt wear condition module 54.

At this point, the seatbelt wear condition module 54 may communicate the occupancy (i.e., the seat 14 is occupied) and the state of the seatbelt assembly 16 (i.e., unbuckled) to the UID control module 58 which, in turn, may communicate the foregoing information to one or more of the internal UID 46, the external UID 60, and the satellite communication network 62 for communication (i.e., via display 50, audible messaging system 47, and/or haptic messaging system 49) to the vehicle occupant(s). As will be described below with respect to FIGS. 7 and 8, the foregoing situation identifies a situation where an occupant is seated on the seat 14 but is unrestrained (i.e., not buckled).

With reference to FIG. 5, an occupant is shown as seated on the seat 14 and in the process of inserting the tongue or latch plate 24 into the seatbelt buckle 22. As shown in FIG. 6, the seat 14 is identified by the occupant detection module 56 as initially being unoccupied at line 70 based on information received from the ODD 42 and/or the remote sensor 44. Once the occupant sits on the seat 14, the occupant detection module 56 identifies the seat 14 as being occupied at line 72. However, as shown in FIG. 5, when the occupant moves in a direction toward the retractor 20 in an effort to facilitate insertion of the tongue or latch plate 24 into the buckle 22, the occupant detection module 56 identifies the seat 14 as being unoccupied at line 74 in FIG. 6. Note that alternatively, the occupant could lean over the buckle 22 to view the buckle 22 or push off of the floor and slide up the seat back while buckling, which would similarly wind up causing the ODD 42 to identify the seat 14 as being unoccupied at line 74 in FIG. 6. The occupant detection module 56 identifies the seat 14 as being unoccupied due to the weight of the occupant shifting at least partially off of the ODD 42, which no longer detects the presence of the occupant on the seat 14. Once the occupant properly engages the tongue or latch plate 24 with the buckle 22 and returns to a position similar to the position shown in FIG. 3, the ODD 42 once again detects the presence of the occupant on the seat 14 at line 76 in FIG. 6.

With continued reference to FIG. 6, the occupant is shown as being unbuckled at line 78 when initially seated on the seat 14. Once the occupant inserts the tongue or latch plate 24 sufficiently into the buckle 22, the buckle sensor 40 detects the presence of the tongue or latch plate 24 and sends a signal to the seatbelt wear condition module 54 that the seatbelt is in the buckled state. The buckled state is identified in FIG. 6 by line 80.

As shown in FIG. 6, at the time of buckling, the ODD 42 did not detect the presence of the occupant on the seat 14. Namely, at line 82—the moment when the seatbelt was buckled—the presence of the occupant on the seat 14 was not detected by the ODD 42. However, as shown in FIG. 5, the occupant was on the seat 14 at the time of buckling but sufficiently lifted off of the ODD 42 to the point where the occupant was no longer detected by the ODD 42.

A variation of the condition shown in FIG. 5 is shown in FIG. 5A. In FIG. 5A, a buckled person is sitting on the seat 14 and is leaning to the side. The resulting occupancy detection by the ODD 42 is similar to what is shown in FIG. 6 with the exception that that the occupant is detected as being buckled and the output by the ODD 42 fluctuates between showing the seat 14 as being occupied and unoccupied. The fluctuation in the detection of occupancy by the ODD 42 is caused by the person—while buckled-leaning or pushing off of the seat bottom 48, thereby causing the ODD 42 to detect intermittent occupancy of the seat 14. FIG. 6A shows the resulting graph over time where the occupant is detected as being buckled and, while buckled, the ODD 42 detects intermittent occupancy. Intermittent occupancy can also be achieved by offloading some of the occupant's weight on an arm rest or adjacent seating surfaces.

With reference to FIGS. 7 and 8, a system and method is provided for use by the seatbelt wear condition module 54 in properly identifying occupancy of a person on a seat 14 at the time of buckling and after buckling even if the occupant detection module 56 does not detect the presence of the occupant on the seat 14 when the seatbelt is buckled.

The seatbelt wear condition module 54 starts in a detection mode at 84 (FIG. 7). The detection mode can be initiated when a door (not shown) of the vehicle system 10 is opened, a remote interior sensor such as the remote sensor 44 detects something in the cabin 12, the vehicle is started, a start ride button (not shown) is pressed, a vehicle door is closed, or the vehicle is placed into a drive mode. At this point, the seatbelt wear condition module 54 may initially determine whether the seatbelt is buckled at 86. As discussed previously, the seatbelt wear condition module 54 may determine whether the seatbelt is buckled based on information received from the buckle sensor 40. If the seatbelt is not buckled at 86, the seatbelt wear condition module 54 may determine if an occupant is seated on the seat 14 at 88. If an occupant is seated on the seat 14 at 88, the seatbelt wear condition module 54 determines that the seat 14 is occupied at 90) and, further, that the seatbelt is not worn. A message would then be communicated via UID control module 58.

If the seat 14 is not occupied at 88, the seatbelt wear condition module 54 determines that the seat 14 is unoccupied at 92 and, further, that the seatbelt is not worn. Whether the seat 14 is occupied or not occupied following 90, 92, the seatbelt wear condition module 54 will determine whether the system is still in the detection mode at 94. If so, the seatbelt wear condition module 54 will return to 86. If not, the seatbelt wear condition module 54 will stop at 96.

Referring back to 86, if the seatbelt wear condition module 54 determines that the seatbelt is buckled, the seatbelt wear condition module 54 determines whether occupancy is detected at the time of buckling at 98 (FIG. 8). If occupancy is detected at the time of buckling, the seatbelt wear condition module 54 determines if occupancy is not detected while buckled at 100 and, regardless of whether occupancy is not detected, determines that the seat 14 is occupied and the seatbelt is worn at 102. In this manner, if intermittent occupancy detection occurs after a person is wearing a seatbelt and the ODD 42 does not detect the occupant for a period of time, the occupancy state does not change and remains as occupancy detected. This approach is based on the observation that it is difficult for a person to exit a seatbelt that is buckled without unbuckling the seatbelt, whereas intermittent occupancy detection can occur with a degree of frequency for some smaller people or people with objects between themselves and a remote occupancy sensor while they have the seatbelt buckled around them.

Once it is determined that the seat 14 is occupied and the seatbelt is worn at 102, the seatbelt wear condition module 54 continues to monitor the buckle sensor 40 to determine whether the seatbelt is unbuckled at 104. If the seatbelt is unbuckled at 104, the seatbelt wear condition module 54 returns to 88 (FIG. 7). If the seatbelt is buckled at 104, the seatbelt wear condition module 54 determines whether the system is still in the detection mode at 106 and if so, returns to 100 (FIG. 8). If the system is no longer in the detection mode, the seatbelt wear condition module 54 stops at 108.

Referring back to 98, if the seatbelt wear condition module 54 determines that the seat 14 is unoccupied at the time of buckling, the seatbelt wear condition module 54 determines whether occupancy was detected during a period of time prior to buckling at 110. The period of time is defined by a pre-buckling duration of time threshold and, in one example, is approximately equal to a duration range between two (2) and ten (10) seconds. If the seatbelt wear condition module 54 determines-based on information from the occupant detection module 56—that an occupant was present on the seat 14 within the pre-buckling duration of time threshold between two (2) and ten (10) seconds preceding buckling of the seatbelt, the seatbelt wear condition module 54 moves to 100. At this point, the seatbelt wear condition module 54 determines whether occupancy is detected or not detected while buckled at 100 and, ultimately, determines that the seat 14 is occupied and the seatbelt is buckled at 102 regardless of the detected occupancy state at 100. The pre-buckling duration of time threshold could be a calibratable or hard-coded threshold in software logic of the seatbelt wear condition module 54.

While the seatbelt wear condition module 54 determines whether occupancy was detected during a period of time prior to buckling at 110, the seatbelt wear condition module 54 could also determine occupancy by monitoring whether the seat 14 is occupied following buckling. For example, the seatbelt wear condition module 54 can determine that the seat 14 was not occupied at the time of buckling if the occupancy sensor determines that the seat 14 is not occupied within the pre-buckling duration of time threshold between two (2) and ten (10) seconds prior to and including the time when the tongue or latch plate 24 is secured to the buckle 22. Based on the foregoing, a time window spanning the time of buckling may be monitored by the seatbelt wear condition module 54 to determine if the seat 14 was occupied after the time of buckling using a post duration of time threshold between ¼ of a second to ten (10) seconds. Using this time duration threshold, the seatbelt wear condition module 54 determines that the seat 14 was occupied after the time of buckling if occupancy is detected for an amount of time exceeding the post duration of time threshold following the buckling event. Also, the seatbelt wear condition module 54 determines that the seat 14 was not occupied after the time of buckling if no occupancy is detected that is within or longer than the post duration of time threshold. The post duration of time threshold could be a calibratable or hard-coded threshold in the software logic of the wear condition module 54 or could be logic requiring a certain number of sensor samples out of a certain size collection of sensor samples to output the same detection state. For instance, an occupancy state change could be determined to have occurred if four (4) out of the last five (5) samples in a moving window of samples return the same output.

If the seatbelt wear condition module 54 determines that occupancy was not detected during a period of time prior to buckling at 110, the seatbelt wear condition module 54 determines that the seat 14 is not occupied at the time of buckling at 112. The seatbelt wear condition module 54 then determines if occupancy is detected while the seatbelt is buckled at 114. If so, the seatbelt wear condition module 54 determines that the seat 14 is occupied and the seatbelt is likely improperly worn at 116. Following determination that the seatbelt could be improperly worn at 116, the seatbelt wear condition module 54 may alert vehicle occupant(s) that an occupant is seated on a seat 14 and is likely not buckled properly via the UID control module 58.

If occupancy is not detected at 114, the seatbelt wear condition module 54 determines that the seat 14 is not occupied at 118. For instance, the seatbelt could be buckled over an empty seat 14 or an object (not an occupant) could be on the seat 14 and not detected as an occupant by the occupancy sensor. If the seat 14 is determined to be occupied at 116 or unoccupied at 118, the seatbelt wear condition module 54 will monitor whether the seatbelt is unbuckled at 120. If so, the seatbelt wear condition module 54 returns to 88 (FIG. 7) to determine whether occupancy is detected. If not, the seatbelt wear condition module 54 determines whether the system is in the detection mode at 122. If so, the seatbelt wear condition module 54 returns to 114 to determine whether occupancy is detected while buckled. If not, the seatbelt wear condition module 54 stops at 124.

With particular reference to FIGS. 9 and 10, the seatbelt wear condition module 54 may reduce an in-seat sensor occupancy threshold for occupancy detection to a lower magnitude once occupancy has been continuously detected for a selected period of time. Lowering the in-seat occupancy threshold reduces the likelihood that the occupancy sensor will fail to detect an occupant seated on the seat 14 should the occupant shift as shown in FIG. 5 from the position shown in FIG. 3 or otherwise move so that the occupancy sensor has difficulty determining if the occupant is present.

In reducing the in-seat sensor threshold, the seatbelt wear condition module 54 can determine whether occupancy is continuously detected for a predetermined period of time at any step in the flowcharts of FIGS. 7 and 8 where occupancy is detected. FIG. 10 schematically represents that the seatbelt wear condition module 54 can evaluate occupancy detection at any point on the flowcharts of FIGS. 7 and 8 at 126. At 128, the seatbelt wear condition module 54 determines whether occupancy is continuously detected for a period of time. If so, the seatbelt wear condition module 54 adjusts the in-seat occupancy threshold to a lower magnitude at 130 and then at 132 returns to monitoring locations where occupancy is monitored in the flowcharts of FIGS. 7 and 8. If occupancy is not continuously detected at 128, the seatbelt wear condition module 54 returns at 132 to monitoring locations where occupancy is monitored in the flowcharts of FIGS. 7 and 8 but references a higher in-seat occupancy threshold. In all cases for all sensors, the method may optionally look at multiple sensor samples to determine a state change. The method could, for instance, determine a state change takes place if four (4) of the last five (5) samples output the same new state and may determine that a state change has not taken place if less than four (4) of the last five (5) samples output the same new state.

The foregoing system and method provides the seatbelt wear condition module 54 with the ability to detect occupancy during conditions where the occupancy sensor does not detect the presence of an occupant on a seat 14 when, in fact, an occupant is seated on the seat 14. The seatbelt wear condition module 54 is capable of deciphering intermittent signals from the occupancy sensor caused by obscuration or occupant movement (FIG. 5) before buckling, during buckling, or after buckling to properly determine the presence of an occupant on the seat 14.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system comprising:
an occupant detection module configured to identify a state of a vehicle seat, the occupant detection module identifying an occupied state when an occupant is seated on the vehicle seat and an unoccupied state when the vehicle seat is free from an occupant;
a buckle sensor configured to detect a buckled state when a latch plate is secured to a buckle of a seatbelt and an unbuckled state when the buckle is separated from a latch plate, the buckle sensor identifying a time of buckling when the latch plate is initially secured to the buckle; and
a seatbelt wear condition module in communication with the buckle sensor and the occupant detection module and configured to identify the occupied state at the time of buckling and after buckling regardless of whether the occupant detection module detects the occupied state at the time of buckling or the unoccupied state at the time of buckling based on the occupant detection module identifying the occupied state prior to the time of buckling.

2. The system of claim 1, wherein the seatbelt wear condition module is configured to detect the occupied state at the time of buckling based on the occupant detection module identifying the occupied state within a window of time starting before the time of buckling and ending at and including the time of buckling.

3. The system of claim 1, wherein the predetermined timeframe falls within an approximate timeframe from two (2) to ten (10) seconds.

4. The system of claim 1, wherein the seatbelt wear condition module identifies the occupied state at the time of buckling regardless of whether the occupant detection module detects intermittent occupancy at the time of buckling based on the occupant detection module identifying the occupied state within a predetermined timeframe prior to the time of buckling, at a point-in-time during buckling, or during a timeframe after buckling.

5. The system of claim 4, wherein the predetermined timeframe falls within an approximate timeframe from two (2) to ten (10) seconds starting before the time of buckling and ending at and including the time of buckling.

6. The system of claim 1, wherein the occupant detection module is in communication with at least one occupancy sensor configured to determine the presence of an occupant on the vehicle seat.

7. The system of claim 6, wherein the at least one occupancy sensor includes at least one of a pressure sensor, a weight sensor, a resistive sensor, a biometric sensor, and a capacitive sensor located in the vehicle seat and a remote sensor including at least one of a camera, radar, and LIDAR having a field-of-view that encompasses the vehicle seat.

8. The system of claim 1, wherein the seatbelt wear condition module stores the state of the vehicle seat as detected by an occupancy sensor for a continuous fixed duration moving time window prior to and including the time of buckling.

9. A system comprising:
an occupant detection module configured to identify a state of a vehicle seat, the occupant detection module identifying an occupied state when an occupant is seated on the vehicle seat and an unoccupied state when the vehicle seat is free from an occupant;
a buckle sensor configured to detect a buckled state when a latch plate is secured to a buckle of a seatbelt and an unbuckled state when the buckle is separated from a latch plate, the buckle sensor identifying a time of buckling when the latch plate is initially secured to the buckle; and
a seatbelt wear condition module in communication with the buckle sensor and the occupant detection module and configured to identify the occupied state at the time of buckling regardless of whether the occupant detection module detects the occupied state at the time of buckling or the unoccupied state at the time of buckling based on the occupant detection module identifying the occupied state within a predetermined timeframe prior to and including the time of buckling.

10. The system of claim 9, wherein the seatbelt wear condition module is configured to communicate the occupancy of the vehicle seat at the time of buckling to at least one of an internal user interface device and an external user interface device.

11. The system of claim 9, wherein the predetermined timeframe falls within an approximate timeframe from two (2) to ten (10) seconds.

12. The system of claim 9, wherein the seatbelt wear condition module identifies the occupied state at the time of buckling regardless of whether the occupant detection module detects intermittent occupancy at the time of buckling based on the occupant detection module identifying the occupied state within the predetermined timeframe prior to the time of buckling, at a point-in-time during buckling, or during a timeframe after buckling.

13. The system of claim 12, wherein the predetermined timeframe falls within an approximate timeframe from two (2) to ten (10) seconds starting before the time of buckling and ending at and including the time of buckling.

14. The system of claim 9, wherein the occupant detection module is in communication with at least one occupancy sensor configured to determine the presence of an occupant on the vehicle seat.

15. The system of claim 14, wherein the at least one occupancy sensor includes at least one of a pressure sensor, a weight sensor, a resistive sensor, a biometric sensor, and a capacitive sensor located in the vehicle seat and a remote sensor including at least one of a camera, radar, and LIDAR having a field-of-view that encompasses the vehicle seat.

16. The system of claim 9, wherein the seatbelt wear condition module stores the state of the vehicle seat as detected by an occupancy sensor for a continuous fixed duration moving time window prior to and including the time of buckling.

17. A system comprising:
an occupant detection module configured to identify a state of a vehicle seat, the occupant detection module identifying an occupied state when an occupant is seated on the vehicle seat and an unoccupied state when the vehicle seat is free from an occupant;
a buckle sensor configured to detect a buckled state when a latch plate is secured to a buckle of a seatbelt and an unbuckled state when the buckle is separated from a latch plate, the buckle sensor identifying a time of buckling when the latch plate is initially secured to the buckle; and
a seatbelt wear condition module in communication with the buckle sensor and the occupant detection module and configured to identify the occupied state after a buckling event while the seatbelt remains buckled regardless of whether the occupant detection module detects the occupied state after the buckling event while the seatbelt remains buckled or the unoccupied state after the buckling event while the seatbelt remains buckled based on the occupied state being determined at buckling.

18. The system of claim 17, wherein the seatbelt wear condition module identifies the occupied state after buckling when the seatbelt remains buckled if the occupant detection module detects an unoccupied state after buckling while remaining buckled.

19. The system of claim 17, wherein the occupant detection module is in communication with at least one occupancy sensor configured to determine the presence of an occupant on the vehicle seat.

20. The system of claim 19, wherein the at least one sensor includes at least one of a pressure sensor, a weight sensor, a resistive sensor, a biometric sensor, and a capacitive sensor located in the vehicle seat and a remote sensor including at least one of a camera, radar, and LIDAR having a field-of-view that encompasses the vehicle seat.
